(19) United States
(12) Patent Application Publication
(10) Pub. No.: US 2005/0078066 A1
(43) Pub. Date: Apr. 14, 2005

(54) Electro-luminescence display device

(75) Inventors: Hak Su Kim, Seoul (KR); Won Kyu Ha, Kyoungsangbuk-do (KR)

Correspondence Address: BIRCH STEWART KOLASCH & BIRCH, PO BOX 747, FALLS CHURCH, VA, 22040-0747, US

(73) Assignee: LG ELECTRONICS INC.

(21) Appl. No.: 10/962,487

(22) Filed: Oct. 13, 2004

(30) Foreign Application Priority Data
Oct. 14, 2003 (KR) P2003-71497

(51) Int. Cl. G09G 3/30

(52) U.S. Cl. 345/80

(57) ABSTRACT

An electro-luminescence display device for maximizing an area of a picture display part provided on a certain size of substrate is disclosed. In the electro-luminescence display device, an electro-luminescence display part has a plurality of pixels arranged for each area defined by intersections between gate lines and data lines provided on a substrate. A first gate driver is provided at the left side of the electro-luminescence display part to drive a portion of the gate lines. A second gate driver is provided at the right side of the electro-luminescence display part to drive the remaining gate lines other than said portion of the gate lines. A data driver is provided at any one of the upper and lower sides of the electro-luminescence display part to drive the data lines.

This application claims the benefit of Korean Patent Application No. P2003-71497 filed in Korea on Oct. 14, 2003, which is hereby incorporated by reference.

### BACKGROUND OF THE INVENTION

1. Field of the Invention

This invention relates to an electro-luminescence display (ELD), and more particularly to an electro-luminescence display device that is adaptive for maximizing an area of a picture display part provided on a certain size of substrate.

2. Description of the Related Art

Recently, there have been highlighted various flat panel display devices reduced in weight and bulk that is capable of eliminating disadvantages of a cathode ray tube (CRT). Such flat panel display devices include a liquid crystal display (LCD), a field emission display (FED), a plasma display panel (PDP) and an electro-luminescence (EL) display, etc.

The EL display in such display devices is a self-luminous device capable of light-emitting a phosphorous material by a re-combination of electrons with holes. The EL display device is generally classified into an inorganic EL device using the phosphorous material as an inorganic compound and an organic using it as an organic compound. Such an EL display device has many advantages of a low voltage driving, a self-luminescence, a thin-thickness, a wide viewing angle, a fast response speed and a high contrast, etc. such that it can be highlighted into a post-generation display device.

The organic EL device is usually comprised of an electron injection layer, an electron carrier layer, a light-emitting layer, a hole carrier layer and a hole injection layer that are disposed between a cathode and an anode. In such an organic EL device, when a predetermined voltage is applied between an anode and a cathode, electrons produced from the cathode are moved, via the electron injection layer and the electron carrier layer, into the light-emitting layer while holes produced from the anode are moved, via the hole injection layer and the hole carrier layer, into the light-emitting layer. Thus, the electrons and the holes fed from the electron carrier layer and the hole carrier layer emit a light by their re-combination at the light-emitting layer.

Referring to FIG. 1, a conventional EL display includes a substrate 10, an EL display part 12 having pixels 28 arranged for each area defined by intersections between gate lines GL and data lines DL, a gate driver 22 provided at one side of the substrate 10 to drive the gate lines GL of the EL display part 12, and a data driver 24 provided at the lower side of the substrate 10 to drive the data lines DL of the EL display part 12.

Each of the pixels 28 receives a data signal from the data line DL when a gate pulse is applied to the gate line GL to generate a light corresponding to the data signal. The EL display part 12 consisting of such pixels 28 is provided on the substrate 10 in such a manner to have a certain of area and width W1 depending upon a resolution.

The gate driver 22 is provided at the substrate 10 at a predetermined distance from one side of the EL display part 12 to be connected to each gate line GL. The gate driver 22 applies gate pulses to the gate lines GL to sequentially drive the gate lines GL. In this case, as shown in FIG. 2, the gate driver 22 has a predetermined width GW by a plurality of gate shift registers 23 for driving each gate line GL.

Each of the gate shift registers 23 shifts a start pulse SP inputted from the exterior thereof into an input terminal IN in response to an input clock signal CLK to generate a gate pulse, and applies the generated gate pulse, via an output terminal OUT, to the gate line GL. In this case, each gate shift register 23 consists of circuit devices (not shown) including a plurality of thin film transistors for shifting the start pulse SP to generate the gate pulse. The circuit devices of each gate shift register 23 are provided lengthily in the horizontal direction, that is, in such a manner to have a rectangular area by a distance between adjacent gate lines GL. In other words, the circuit devices of each gate shift register 23 are provided only at the side space of each gate line GL because the distance between the adjacent gate lines GL. Thus, a width GW of the gate driver 22 is lengthened in a X-axis direction by the circuit devices of the gate shift register 23 for driving one gate line GL.

The data driver 24 is connected to each data line DL at a predetermined distance from the lower side of the EL display part 12. The data driver 24 converts digital data signals inputted from the exterior thereof into analog data signals using gamma voltages. Further, the data driver 24 applies the analog data signals to the data lines DL whenever the gate pulses are applied.

The EL display further includes a packaging plate (not shown) joined with the substrate 10 for the purpose of protecting the EL display part 12 from oxygen and moisture. In order to join the packaging plate with the substrate 10, a sealant 30 having a predetermined width SW is coated on the outer sides of the gate driver 22, the data driver 24 and the EL display part 12.

Meanwhile, the conventional EL display includes a first gap G1 between the gate driver 22 and the EL display part 12, a second gap G2 between the gate driver 22 and the sealant 30, and a third gap G3 between a scribing line for separating the EL display device from the substrate 10 and the sealant 30 in order to assure a process margin upon its manufacturing process. The EL display further includes a dummy space 62 defined between the EL display part 12 and the sealant 30 (i.e., at the right side of the EL display part 12 having not provided with the gate driver 22 and the sealant 30) such that the EL display part 12 of the completed EL display is located at the center portion of the substrate 10. A width of the dummy space 62 corresponds to the width GW of the gate driver 22 and the first and second gaps G1 and G2.

Accordingly, the conventional EL display can not enlarge an area of the EL display part 12 due to the width GW of the gate driver 22 and the first to third gaps G1 to G3 because it is provided on the substrate 10 at a certain size depending upon a resolution of the EL display part 12. Furthermore, the conventional EL display has to enlarge a size of the substrate 10 when it is intended to be enlarged into an area of the EL display part having a certain resolution.

Moreover, the conventional EL display has a problem in that, since the width GW of the gate driver 22 is enlarged when a resolution of the EL display part 12 provided at a certain substrate 10 is increased, a size of the substrate 10 must be enlarged.

### SUMMARY OF THE INVENTION

Accordingly, it is an object of the present invention to provide an electro-luminescence display device that is adaptive for maximizing an area of a picture display part provided on a certain size of substrate.

In order to achieve these and other objects of the invention, an electro-luminescence display device according to an embodiment of the present invention includes a substrate; an electro-luminescence display part having a plurality of pixels arranged for each area defined by intersections between gate lines and data lines provided on the substrate; a first gate driver provided at the left side of the electro-luminescence display part to drive a portion of the gate lines; a second gate driver provided at the right side of the electro-luminescence display part to drive the remaining gate lines other than said portion of the gate lines; and a data driver provided at any one of the upper and lower sides of the electro-luminescence display part to drive the data lines.

The electro-luminescence display device further includes a sealant coated onto the outer sides of the gate driver, the electro-luminescence display part and the data driver.

In the electro-luminescence display device, each of the first and second gate drivers includes a plurality of shift registers for sequentially shifting a start pulse to generate a gate pulse for sequentially driving the gate lines.

Herein, each of shift registers of the first gate driver includes circuit devices provided at one side space of odd-numbered gate lines and one side space of even-numbered gate lines arranged above or under it.

Each of shift registers of the second gate driver includes circuit devices provided at other side space of even-numbered gate lines and other side space of odd-numbered gate lines arranged above or under it.

An electro-luminescence display device, in which a plurality of electrodes and a driving circuit for driving the electrodes are provided on a substrate, according to another embodiment of the present invention includes a first driving circuit provided at a first position of the substrate to drive a first electrode group of the plurality of electrodes; and a second driving circuit provided at a second position of the substrate to drive a second electrode group of the plurality of electrodes.

In the electro-luminescence display device, the plurality of electrodes include a plurality of data electrodes; and a plurality of gate electrodes crossing the data electrodes.

Herein, the first electrode group includes a portion of the plurality of gate electrodes.

Herein, the second electrode group includes the remaining electrodes other than said portion of the plurality of gate electrodes.

In the electro-luminescence display device, the first electrode group includes a portion of the plurality of data electrodes.

Herein, the second electrode group includes the remaining electrodes other than said portion of the plurality of data electrodes.

An electro-luminescence display device, having a plurality of data lines, a plurality of gate lines, a data driving circuit for driving the data lines and a gate driving circuit for driving the gate lines, according to still another embodiment of the present invention includes an electro-luminescence display part having a plurality of pixels arranged for each area defined by intersections between the gate lines and the data lines provided on a substrate; a first gate driver connected to a first gate electrode group of the gate lines and provided at a first side of the outer side of the electro-luminescence display part; a second gate driver connected to a second gate electrode group of the gate lines and provided at a second side of the outer side of the electro-luminescence display part; a first data driver connected to a first data electrode group of the data lines and provided at a third side of the outer side of the electro-luminescence display part; and a second data driver connected to a second gate electrode group of the data lines and provided at a fourth side of the outer side of the electro-luminescence display part.

In the electro-luminescence display device, the first gate electrode group includes odd-numbered gate electrodes.

Herein, the second gate electrode group includes even-numbered gate electrodes.

In the electro-luminescence display device, the first data electrode group includes odd-numbered data electrodes.

Herein, the second data electrode group includes even-numbered data electrodes.

In the electro-luminescence display device, said first side is the left side of the electro-luminescence display part.

Herein, said second side is the right side of the electro-luminescence display part.

Herein, said third side is the upper side of the electro-luminescence display part.

Herein, said fourth side is the lower side of the electro-luminescence display part.

### BRIEF DESCRIPTION OF THE DRAWINGS

These and other objects of the invention will be apparent from the following detailed description of the embodiments of the present invention with reference to the accompanying drawings, in which:

FIG. 1 is a schematic plan view showing a structure of a conventional electro-luminescence panel;

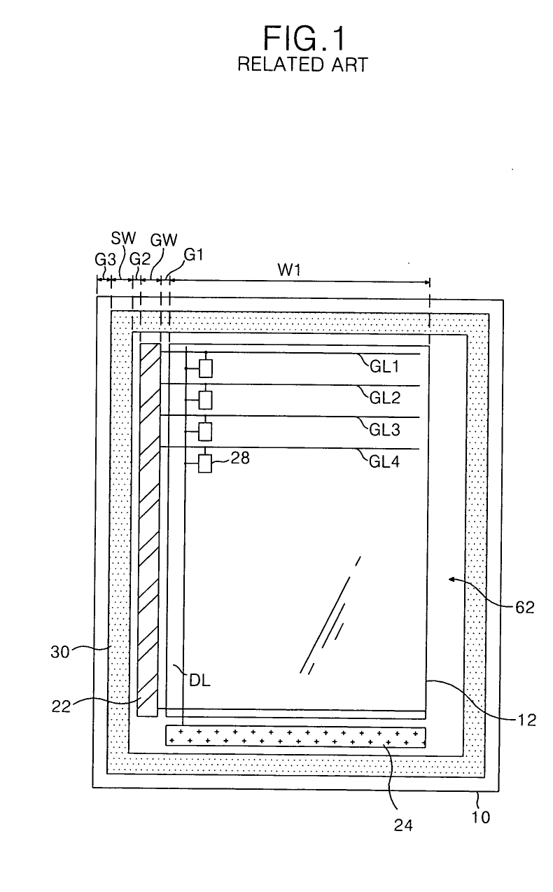

FIG. 2 illustrates the shift register of the gate driver shown in FIG. 1;

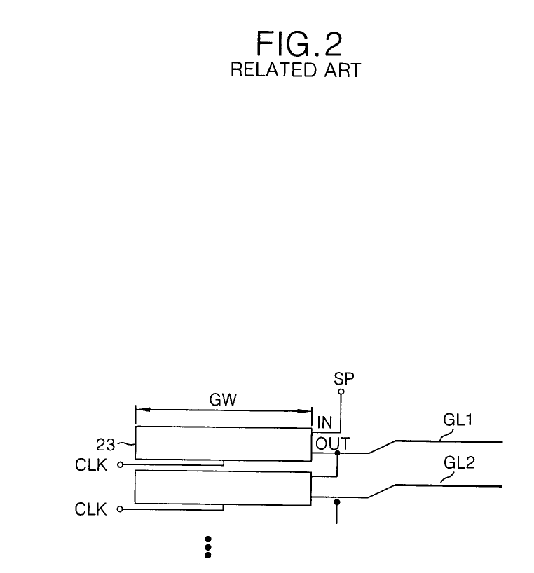

FIG. 3 is a schematic plan view showing a structure of an electro-luminescence display device according to an embodiment of the present invention;

FIG. 4 is an equivalent circuit diagram of a pixel consisting of two transistors shown in FIG. 3;

FIG. 5 is an equivalent circuit diagram of a pixel consisting of four transistors shown in FIG. 3;

FIG. 6 illustrates the shift registers of the first and second gate drivers shown in FIG. 3;

FIG. 7 is a schematic plan view showing a structure of an electro-luminescence display device according to another embodiment of the present invention; and

FIG. 8 is a schematic plan view showing a structure of an electro-luminescence display device according to still another embodiment of the present invention.

### DETAILED DESCRIPTION OF THE PREFERRED EMBODIMENT

Reference will now be made in detail to the preferred embodiments of the present invention, examples of which are illustrated in the accompanying drawings.

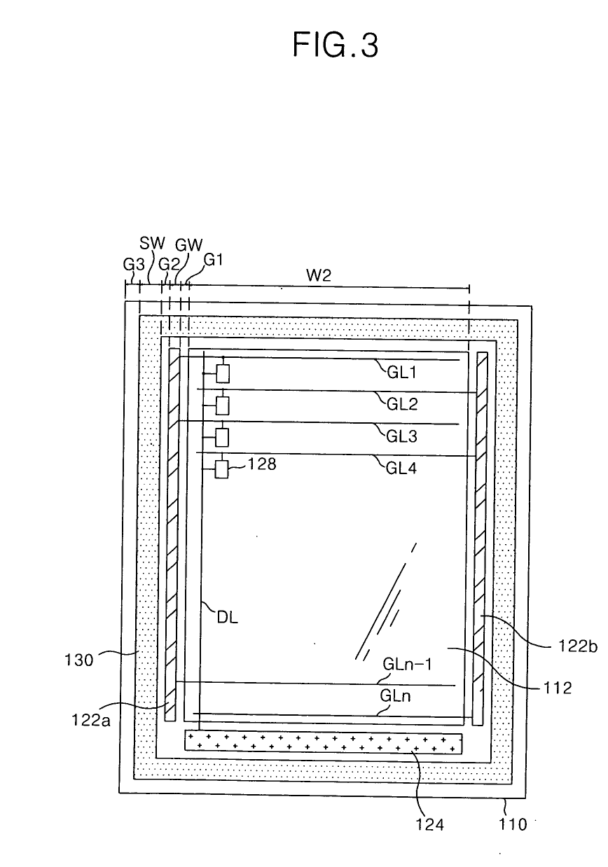

Hereinafter, the preferred embodiments of the present invention will be described in detail with reference to FIGS. 3 to 8.

Referring to FIG. 3, an electro-luminescence (EL) display device according to an embodiment of the present invention includes a substrate 110, an EL display part 112 having pixels 128 arranged for each area defined by intersections between gate lines GL and data lines DL, a first gate driver 122a provided at the left side of the substrate 10 to drive odd-numbered gate lines GL1, GL3, . . . , GLn-1 of the gate lines GL, a second gate driver 122b provided at the right side of the substrate 110 to drive even-numbered gate lines GL2, GL4, . . . , GLn of the gate lines GL, and a data driver 124 provided at the lower side of the substrate 10 to drive the data lines DL of the EL display part 112.

Each of the pixels 128 is selected when a gate signal is applied to the gate line GL as a cathode, thereby generating a light corresponding to a pixel signal applied to the data line DL as an anode, that is, a current signal.

More specifically, each pixel 128 can be equivalently expressed as a diode connected between the data line DL and the gate line GL. Each pixel 128 is driven when a gate signal is enabled to the gate line GL to thereby generate a light corresponding to a magnitude of the data signal at the data line DL.

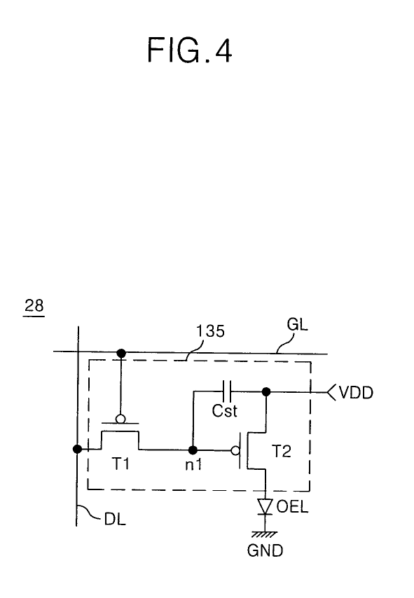

To this end, as shown in FIG. 4, each pixel 128 includes a supply voltage line VDD, a light-emitting cell OEL connected between the supply voltage line VDD and a ground voltage source GND, and a light-emitting cell driving circuit 135 for driving the light-emitting cell OEL in response to a driving signal supplied from each of the data line DL and the gate line GL.

The light-emitting cell OEL is comprised of an electron injection layer, an electron carrier layer, a light-emitting layer, a hole carrier layer and a hole injection layer that are disposed between a cathode and an anode (not shown). In such a light-emitting cell OEL, when a voltage is applied between an anode that is a transparent electrode and a cathode that is a metal electrode, electrons produced from the cathode are moved, via the electron injection layer and the electron carrier layer, into the light-emitting layer while holes produced from the anode are moved, via the hole injection layer and the hole carrier layer, into the light-emitting layer. Thus, the electrons and the holes fed from the electron carrier layer and the hole carrier layer emit a light by their re-combination at the light-emitting layer. This light is emitted, via the anode that is a transparent electrode, into the exterior thereof, thereby displaying a picture.

The light-emitting cell driving circuit 135 includes a switching thin film transistor (TFT) T1 connected to the gate line GL and the data line DL, a driving TFT T2 connected between the switching TFT T1 and the light-emitting cell OEL, and a capacitor Cst connected between a first node n1 positioned between the switching TFT T1 and the driving TFT T2 and the source terminal of the driving TFT T2 connected to the supply voltage line VDD.

The switching TFT T1 has a gate terminal connected to the gate line GL, a source terminal connected to the data line DL and a drain terminal connected, via the first node n1, to the gate terminal of the driving TFT T2. The switching TFT T1 is turned on when a gate pulse is applied to the gate line GL, to thereby apply a data signal supplied to the data line DL to the first node n1. The data signal supplied to the first node n1 is charged into the capacitor Cst and is applied to the gate terminal of the driving TFT T2.

The driving TFT T2 has a gate terminal connected, via the first node n1, to the drain terminal of the switching TFT T1 and a drain terminal connected to the light-emitting cell OEL. The driving TFT T2 controls a current amount fed from the supply voltage line VDD into the light-emitting cell OEL in response to the data signal applied to the gate terminal thereof, thereby controlling a light-emission amount of the light-emitting cell OEL. Further, since a data signal is discharged from the capacitor Cst even though the switching TFT T1 is turned off, the driving TFT T2 applies a current from the supply voltage line VDD to the light-emitting cell OEL until a data signal at the next frame is supplied, thereby keeping a light emission of the light-emitting cell OEL.

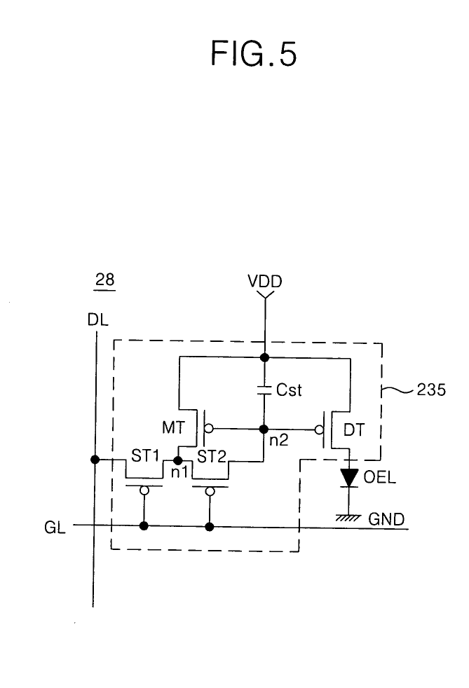

Alternatively, as shown in FIG. 5, each pixel cell 128 may be configured by a light-emitting cell driving circuit 235 consisting of four TFT's DT, MT, ST1 and ST2.

More specifically, the light-emitting cell driving circuit 235 includes a driving TFT DT connected between the supply voltage line VDD and the light-emitting cell OEL, a first switching TFT ST1 connected between the gate line GL and the data line DL, a second switching TFT ST2 connected between the first switching TFT ST1 and the gate line GL, and a converting TFT MT connected between the first node n1 positioned between the first and second switching TFT's ST1 and ST2 and the supply voltage line VDD to form a current mirror circuit with respect to the driving TFT DT, thereby converting a current into a voltage, and a capacitor Cst connected between a second node n2 positioned between the driving TFT DT and the gate terminal of each converting TFT MT and the supply voltage line VDD. Herein, the TFT is a metal-oxide semiconductor field effect transistor (MOSFET).

The driving TFT DT has a gate terminal connected to the gate terminal of the converting TFT MT, a source terminal connected to the supply voltage line VDD and a drain terminal connected to the light-emitting cell OEL.

The converting TFT MT has a source terminal connected to the supply voltage line VDD and a drain terminal connected to the drain terminal of the first switching TFT ST1 and the source terminal of the second switching TFT ST2. The source terminal of the first switching TFT ST1 is connected to the data line DL while the drain terminal thereof is connected to the source terminal of the second switching TFT ST2. The drain terminal of the second switching TFT ST2 is connected to the gate terminals of the driving TFT DT and the converting TFT MT and the capacitor Cst. The gate terminals of the first and second switching TFT's ST1 and ST2 are connected to the gate line GL. If it is assumed that the converting TFT MT and the driving TFT DT have the same characteristic because they are provided adjacently with each other to form a current mirror circuit, a current amount flowing in the converting TFT MT becomes equal to a current amount flowing in the driving TFT DT when the converting TFT MT and the driving TFT DT is provided to have the same dimension.

Hereinafter, a driving of the light-emitting cell driving circuit 235 will be described.

Firstly, if an ON state of gate pulse is applied to the gate line GL, then the first and second switching TFT's ST1 and ST2 are turned on. As the first and second switching TFT's ST1 and ST2 are turned on, the driving TFT DT and the converting TFT MT is turned on by a data signal supplied, via the first and second switching TFT's ST1 and ST2, from the data line DL. Thus, the driving TFT DT controls a current between the source terminal and the drain terminal thereof fed from the supply voltage line VDD in response to a data signal supplied to the gate terminal thereof to apply the controlled current to the light-emitting cell OEL, thereby radiating the light-emitting cell OEL into a brightness corresponding to the data signal.

On the other hand, if an OFF state of gate pulse is applied to the gate line GL, then the first and second switching TFT's ST1 and ST2 are turned off. As the first and second switching TFT's ST1 and ST2 are turned off, the capacitor Cst drives the driving TFT DT using the stored voltage. Thus, the driving TFT DT applies a current from the supply voltage line VDD to the light-emitting cell OEL until a data signal at the next frame is supplied, thereby keeping a light-emission of the light-emitting cell OEL.

The EL display part 112 consisting of the pixels 128 is provided at the substrate 110 such that it has a certain of area and width W2 depending upon a resolution thereof.

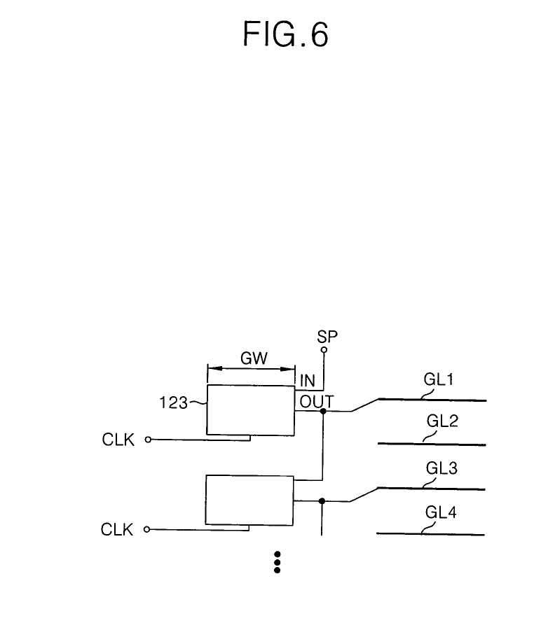

The first gate driver 122a is provided at the left side of the substrate 110 at a predetermined distance from one side of the EL display part 112 to be connected to odd-numbered gate lines GL1, GL3, . . . , GLn-1 of the gate lines GL. The first gate driver 122a applies gate pulses to the odd-numbered gate lines GL1, GL3, . . . , GLn-1 to sequentially drive the gate lines GL. In this case, as shown in FIG. 6, the first gate driver 122a has a predetermined width GW by a plurality of gate shift registers 23 for driving the respective odd-numbered gate lines GL1, GL3, . . . , GLn-1.

Each of the gate shift registers 123 of the first gate driver 122a shifts a start pulse SP inputted from the exterior thereof into an input terminal IN in response to an input clock signal CLK to generate a gate pulse, and applies the generated gate pulse, via an output terminal OUT, to the gate line GL. To this end, each gate shift register 123 of the first gate driver 122a consists of circuit devices (not shown) including a plurality of thin film transistors for shifting the start pulse SP to generate the gate pulse. Accordingly, a width GW of the first gate driver 122a is determined by the number of thin film transistors configuring the plurality of gate shift registers 123 so as to drive one gate line GL. In this case, the plurality of thin film transistors take a regular square shape rather than the existent rectangular shape because a distance between the adjacent odd-numbered gate lines GL1, GL3, . . . , GLn-1 is larger than that in the prior art (i.e., twice of the prior art). For instance, if the plurality of thin film transistors in the prior art are provided in the X-axis direction, then the plurality of thin film transistors in the embodiment of the present invention are provided in the X-axis and Y-axis directions. In other words, the circuit devices of each gate shift register of the first gate driver 122a are provided at each side space of the odd-numbered gate lines GL1, GL3, . . . , GLn-1 and each side space of the even-numbered gate lines GL2, GL4, . . . , GLn arranged above or under it. Thus, an area of a region at which each of the plurality of gate shift registers 123 is provided is equal to the gate shift registers in the prior art, whereas a width thereof is more reduced than the prior art.

Accordingly, a width GW of the first gate driver 122a becomes smaller than that of the conventional gate driver. For instance, the first gate driver 122a drives a half of the n gate lines GL, so that a width of the first gate driver 122a is reduced to a half of the width of the conventional gate driver.

The second gate driver 122b is provided at the right side of the substrate 110 at a predetermined distance from one side of the EL display part 112 to be connected to even-numbered gate lines GL2, GL4, . . . , GLn of the gate lines GL. In other words, the second gate driver 122b is provided at a dummy space defined on the substrate of the conventional EL display. The second gate driver 122b applies gate pulses to even-numbered gate lines GL2, GL4, . . . , GLn to sequentially drive the gate lines GL. In this case, since the second gate driver 122b has the same configuration as the above-mentioned first gate driver 122a, an explanation as to that will be replaced by an explanation of the first gate driver 122a.

The data driver 124 is connected to each data line DL at a predetermined distance from the lower side of the EL display part 112. The data driver 124 converts digital data signals inputted from the exterior thereof into analog data signals using gamma voltages. Further, the data driver 124 applies the analog data signals to the data lines DL whenever the gate pulses are applied.

The EL display further includes a packaging plate (not shown) joined with the substrate 110 for the purpose of protecting the EL display part 112 from oxygen and moisture. In order to join the packaging plate with the substrate 110, a sealant 130 having a predetermined width SW is coated on the outer sides of the gate driver 122, the data driver 124 and the EL display part 112.

Meanwhile, the EL display device according to the embodiment of the present invention includes a first gap G1 between the first gate driver 122a and the EL display part 112, a second gap G2 between the first gate driver 122a and the sealant 130, and a third gap G3 between a scribing line for separating the EL display device from the substrate 110 and the sealant 130 in order to assure a process margin upon its manufacturing process. The first to third gaps G1 to G3 and the width SW of the sealant 130 are equal to those in the convention EL display device.

In the EL display device according to the embodiment of the present invention, the gate driver is divided into two drivers, each of which is provided at the left side or the right side of the substrate 110 around the EL display part 112. Accordingly, the EL display device according to the embodiment of the present invention can not only enlarge the width W2 of the EL display part 112 toward the left side thereof by a width of the gate driver more reduced than the prior art owing to the first gate driver 122a having a smaller width GW than the conventional gate driver, but also can enlarge the width W2 of the EL display part 112 toward the dummy space of the conventional EL display device by the width GW of the second gate driver 122b. Thus, when the EL display part 112 according to the embodiment of the present invention and the conventional EL display part are provided at the substrate 110 having the same dimension, the width W2 of the EL display part 112 according to the embodiment of the present invention becomes larger than the width W1 of the conventional EL display part. As a result, the EL display device according to the embodiment of the present invention can enlarge a width W2 at the left or right side of the EL display part 112 within a range in which a size of the substrate 110 is not increased, thereby maximizing an increase in an area of the EL display part 112.

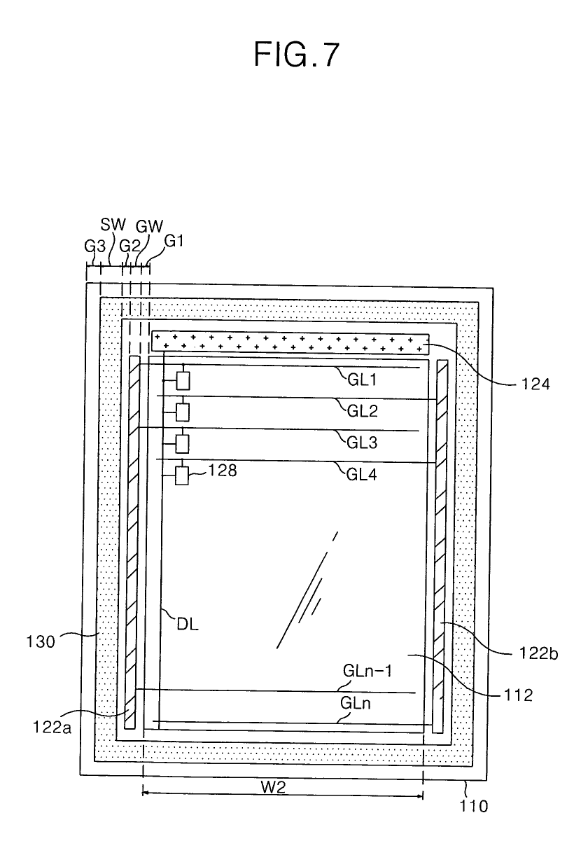

Alternatively, a data driver 124 of an EL display device according to another embodiment of the present invention may be provided at the upper side of the EL display part 112 as shown in FIG. 7.

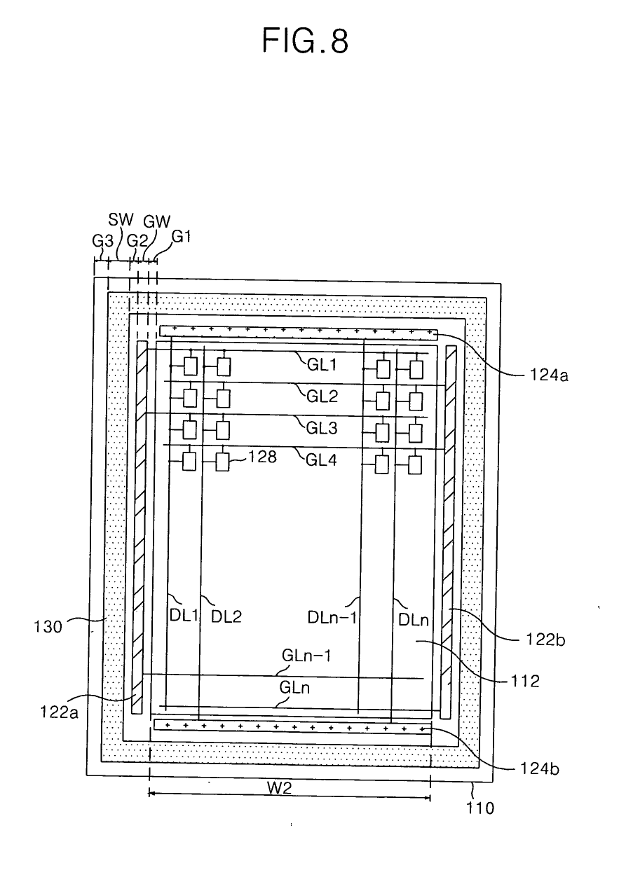

Otherwise, a data driver 124 of an EL display device according to still another embodiment of the present invention may include first and second data drivers 124a and 124b provided at the upper and lower sides of the substrate 110 as shown in FIG. 8.

Herein, the first data driver 124a is provided at the upper side of the substrate 110 to drive odd-numbered data lines DL1, DL3, . . . , DLn-1 of the data lines DL while the second data driver 124b is provided at the lower side of the substrate 110 to drive even-numbered data lines DL2, DL4, . . . , DLn of the data lines DL.

As described above, according to the present invention, the gate driver is provided at the left side or the right side of the EL display part, thereby enlarging the width of the EL display part. Accordingly, it becomes possible to maximize an area of the EL display part provided at the substrate having a certain size depending upon a resolution.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

1. An electro-luminescence display device comprising:
a substrate;
an electro-luminescence display part having a plurality of pixels arranged for each area defined by intersections between gate lines and data lines provided on the substrate;
a first gate driver provided at the left side of the electro-luminescence display part to drive a portion of the gate lines;
a second gate driver provided at the right side of the electro-luminescence display part to drive the remaining gate lines other than said portion of the gate lines; and
a data driver provided at any one of the upper and lower sides of the electro-luminescence display part to drive the data lines.

2. The electro-luminescence display device according to claim 1, further comprising:
a sealant coated onto the outer sides of the gate driver, the electro-luminescence display part and the data driver.

3. The electro-luminescence display device according to claim 2, wherein each of the first and second gate drivers includes:
a plurality of shift registers for sequentially shifting a start pulse to generate a gate pulse for sequentially driving the gate lines.

4. The electro-luminescence display device according to claim 3, wherein each of shift registers of the first gate driver includes:
circuit devices provided at one side space of odd-numbered gate lines and one side space of even-numbered gate lines arranged above or under it.

5. The electro-luminescence display device according to claim 3, wherein each of shift registers of the second gate driver includes:
circuit devices provided at other side space of even-numbered gate lines and other side space of odd-numbered gate lines arranged above or under it.

6. An electro-luminescence display device in which a plurality of electrodes and a driving circuit for driving the electrodes are provided on a substrate, said device comprising:
a first driving circuit provided at a first position of the substrate to drive a first electrode group of the plurality of electrodes; and
a second driving circuit provided at a second position of the substrate to drive a second electrode group of the plurality of electrodes.

7. The electro-luminescence display device according to claim 6, wherein the plurality of electrodes include:
a plurality of data electrodes; and
a plurality of gate electrodes crossing the data electrodes.

8. The electro-luminescence display device according to claim 7, wherein the first electrode group includes:
a portion of the plurality of gate electrodes.

9. The electro-luminescence display device according to claim 8, wherein the second electrode group includes:
the remaining electrodes other than said portion of the plurality of gate electrodes.

10. The electro-luminescence display device according to claim 7, wherein the first electrode group includes:
a portion of the plurality of data electrodes.

11. The electro-luminescence display device according to claim 10, wherein the second electrode group includes:
the remaining electrodes other than said portion of the plurality of data electrodes.

12. An electro-luminescence display device having a plurality of data lines, a plurality of gate lines, a data driving circuit for driving the data lines and a gate driving circuit for driving the gate lines, said device comprising:
an electro-luminescence display part having a plurality of pixels arranged for each area defined by intersections between the gate lines and the data lines provided on a substrate;
a first gate driver connected to a first gate electrode group of the gate lines and provided at a first side of the outer side of the electro-luminescence display part;
a second gate driver connected to a second gate electrode group of the gate lines and provided at a second side of the outer side of the electro-luminescence display part;
a first data driver connected to a first data electrode group of the data lines and provided at a third side of the outer side of the electro-luminescence display part; and
a second data driver connected to a second gate electrode group of the data lines and provided at a fourth side of the outer side of the electro-luminescence display part.

13. The electro-luminescence display device according to claim 12, wherein the first gate electrode group includes:
odd-numbered gate electrodes.

14. The electro-luminescence display device according to claim 13, wherein the second gate electrode group includes:
even-numbered gate electrodes.

15. The electro-luminescence display device according to claim 12, wherein the first data electrode group includes:
odd-numbered data electrodes.

16. The electro-luminescence display device according to claim 15, wherein the second data electrode group includes:
even-numbered data electrodes.

17. The electro-luminescence display device according to claim 12, wherein said first side is the left side of the electro-luminescence display part.

18. The electro-luminescence display device according to claim 17, wherein said second side is the right side of the electro-luminescence display part.

19. The electro-luminescence display device according to claim 18, wherein said third side is the upper side of the electro-luminescence display part.

20. The electro-luminescence display device according to claim 19, wherein said fourth side is the lower side of the electro-luminescence display part.
